(19) United States
(12) Patent Application Publication
(10) Pub. No.: US 2007/0127433 A1
(43) Pub. Date: Jun. 7, 2007

(54) METHOD AND APPARATUS FOR GENERATING SNDCP HEADER IN GPRS COMMUNICATION SYSTEM

(76) Inventor: Chun-Feng Yeh, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/560,369

(22) Filed: Nov. 16, 2006

(30) Foreign Application Priority Data
Nov. 21, 2005 (TW) 094140754

(51) Int. Cl. H04J 3/24; H04L 12/56

(52) U.S. Cl. 370/349; 370/389

(57) ABSTRACT

A method for processing a set of data among N sets of data is provided. The method according to this invention first judges whether the set of data is compressed. If the judging result is NO, a first header is generated for the set of data. The first header includes a first indicator for indicating that the first header does not include a compression information field. If the judging result is YES, and the set of data is the first set of data among the N sets of data, a second header is generated for the set of data. The second header includes a second indicator opposite to the first indicator. The second indicator indicates the second header includes the compression information field.

### BACKGROUND OF THE INVENTION

1. Field of the Invention

This invention is related to a data processing method in communication systems and, more specifically, to a data processing method in GPRS communication systems.

2. Description of the Prior Art

The most popular wireless communication system at the present time is GSM mobile phone communication system. On the other hand, the most popular wired communication system at the present time is the internet. Both of these two networks are now flourishing. However, because GSM networks are connected by circuit-switching, and data in internet networks are transferred by packet-switching, these two types of network operate independently without inter-connections due to the different switching structures.

The establishment and development of GPRS standards has changed the aforementioned independent condition. In GPRS services, plural data switching nodes are added to existing GSM networks. Because the data switching nodes are able to process packets, GSM networks and internet networks can accordingly be connected with each other. Thus, the convenience of wireless communication in GSM networks and the abundant information on internet networks can be shared with each other.

The structure of GPRS networks has a sub-network dependent convergence protocol (SNDCP) layer. The SNDCP layer is used as an inter-connection between a network layer and a data link layer. In the SNDCP layer, user data from upper layers are segmented and compressed, so as to be transferred more efficiently and safely.

In the SNDCP layer, data of different properties are compressed with different algorithms. To let following-up systems know whether the data is compressed and with which algorithm the data is compressed, SNDCP layer generates a header for the data, wherein the header includes two fields: a data compression coding (DCOMP) and a protocol control information compression coding (PCOMP).

Actually, in present conditions, seldom data is compressed in the SNDCP layer. Most of the time, the content in DCOMP and PCOMP fields of a SNDCP header is fixed. In wireless communications, in which efficiency of data transmission is of great importance, the volume of data occupied by the DCOMP and PCOMP fields is also unnecessarily wasteful.

### SUMMARY OF THE INVENTION

To solve the aforementioned problem, the present invention provides methods and apparatuses for processing a set of data among N sets of data in a communication system, wherein N is a natural number. The N sets of data may be data transmitted from upper layers to a SNDCP layer in GPRS communication systems.

The first preferred embodiment, according to this invention, is a data processing method. In this method, it is first judged whether the set of data is compressed. If the set of data is not compressed, a first header is generated for the set of data. The first header includes a first indicator for indicating the first header does not include a compression information field. If the set of data has been compressed, and the set of data is the first set of data among the N sets of data, a second header is generated for the set of data. The second header includes a second indicator opposite to the first indicator, and the second indicator indicates that the second header includes the compression information field.

The second preferred embodiment, according to this invention, is a data processing apparatus. The data processing apparatus includes a first judging module and a first generating module. The first judging module is used for judging whether a set of data has been compressed. The first generating module is operated by a first judging result of the first judging module. If the first judging result is NO, the first generating module generates a first header for the set of data. The first header includes a first indicator for indicating the first header does not include a compression information field.

The advantage and spirit of the invention may be understood by the following recitations together with the appended drawings.

### BRIEF DESCRIPTION OF THE APPENDED DRAWINGS

FIG. 1 illustrates the flowchart of a data processing method in the first preferred embodiment according to this invention.

FIG. 2 illustrates actual examples of applying this invention in SNDCP headers.

FIG. 3 illustrates the block diagram of a data processing apparatus in the second preferred embodiment according to this invention.

### DETAILED DESCRIPTION OF THE INVENTION

One main purpose of this invention is to provide methods and apparatuses for processing a set of data among N sets of data in a communication system, wherein N is a natural number. The communication system may be a mobile station conforming to GPRS specifications. The N sets of data may be data transmitted from upper layers to a SNDCP layer in the mobile station. Under some conditions, if the size of an original data transmitted to the SNDCP layer is larger than the data amount that can be transferred through lower layers each time, the original data will be divided into several smaller data, i.e. the aforementioned N sets of data.

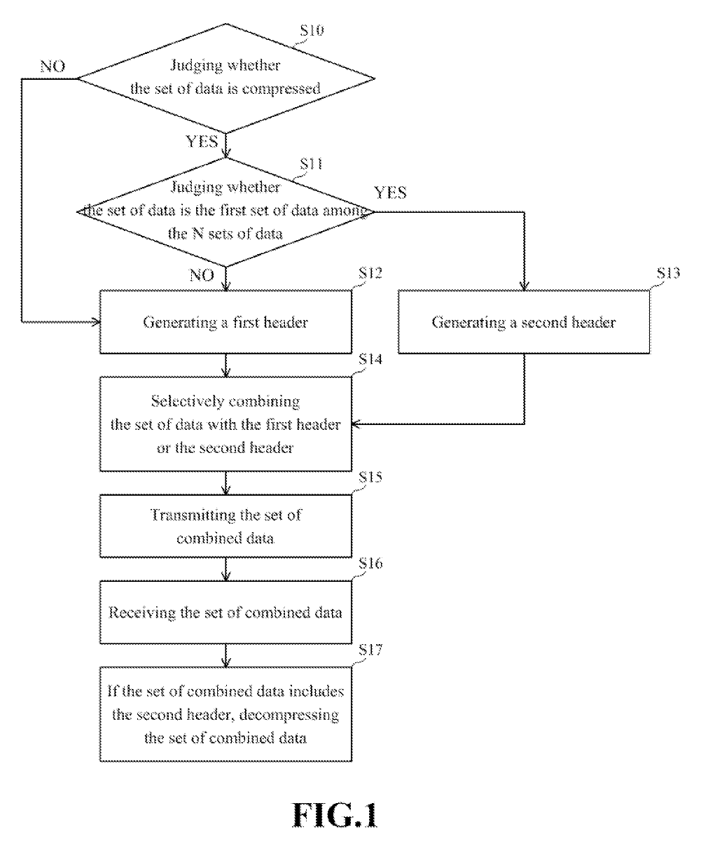

The first preferred embodiment, according to this invention, is a data processing method. Please refer to FIG. 1, which illustrates the flowchart of this data processing method. Step S10 is first performed to judge whether the set of data is compressed. If the set of data is not compressed, step S12 is performed to generate a first header for the set of data. The first header includes a first indicator for indicating that the first header does not include a compression information field. The compression information field can include a DCOMP field and a PCOMP field for recording compression information.

If the judging result of step S10 is YES, step S11 is then performed to judge whether the set of data is the first set of data among the N sets of data. Generally, the N sets of data are divided from one data. The N sets of data would be compressed with the same algorithm. Accordingly, as long as the header of the first set of data among the N sets of data includes a DCOMP field and a PCOMP field, compression information related to the N sets of data are also included.

If the judging result of step S11 is YES, meaning the set of data is the first set of data among the N sets of data, step S13 is then performed to generate a second header for the set of data. The second header includes a second indicator opposite to the first indicator, and the second indicator indicates that the second header includes the compression information field.

In actual applications, this invention can directly mark the first indicator or the second indicator in present SNDCP headers. According to GPRS standards, there is an unused bit in every SNDCP header. Designers can set the unused bit as one to represent the first indicator and set the unused bit as zero to represent the second indicator. In this way, this invention does not have to completely alter the structure of present SNDCP headers.

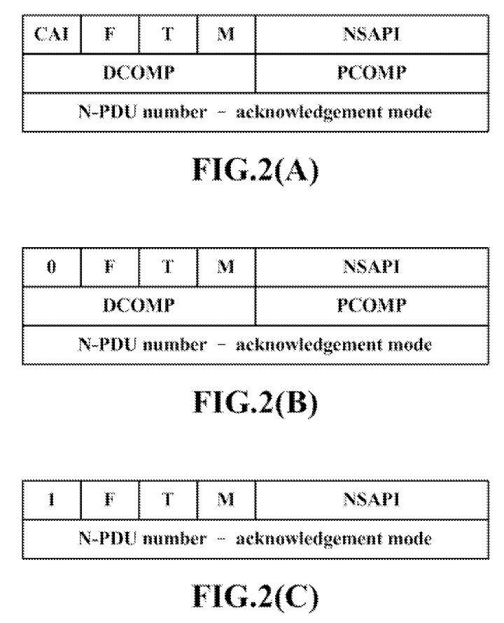

FIG. 2 (A) illustrates a standard SNDCP header. The bit marked as CAI is not used in GPRS standard. Moreover, in prior arts, every SNDCP header includes a DCOMP field and a PCOMP field. According to this invention, users can use the CAI bit to indicate whether this header includes the DCOMP and PCOMP fields. As shown in FIG. 2(B), setting the CAI bit as zero indicates that the header includes the DCOMP and PCOMP fields. In contrast, as shown in FIG. 2(C), setting the CAI bit as one indicates that the header does not include the DCOMP and PCOMP fields.

According to this invention, after steps S12 and S13, step S14 can be performed to selectively combine the set of data with the first header or the second header to generate a set of combined data. In steps S15 and S16, the set of combined data is transmitted and received, respectively. In step S17, it is judged whether the set of combined data includes the first header or the second header. If the set of combined data includes the second header, the set of combined data should be decompressed before being further processed. In contrast, if the set of combined data includes the first header, the set of combined data may not have to be decompressed, or the set of combined data is not the first set of data among the N sets of data.

In actual applications, the communication system might include a first end and a second end. Steps S15 and S16 can be respectively performed at the first end and the second end.

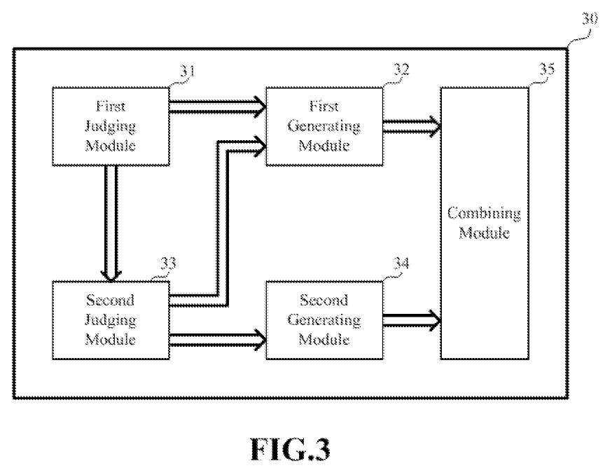

The second preferred embodiment, according to this invention, is a data processing apparatus. FIG. 3 illustrates the block diagram of the data processing apparatus 30 in the second preferred embodiment. The data processing apparatus 30 includes a first judging module 31, a first generating module 32, a second judging module 33, a second generating module 34, and a combining module 35.

The first judging module 31 is used for judging whether a set of data is compressed. The first generating module 32 is operated by a first judging result of the first judging module 31. If the first judging result is NO, the first generating module 32 generates a first header for the set of data. The first header includes a first indicator for indicating that the first header does not include a compression information field.

The second judging module 33 is also operated by the first judging result of the first judging module 31. If the first judging result is YES, the second judging module 33 then judges whether the set of data is the first set of data among the N sets of data. If a second judging result of the second judging module 33 is NO, the second judging module 33 also operates the first generating module 32 to generate the first header for the set of data.

The second generating module 34 is operated by the second judging result of the second judging module 33. If the second judging result is YES, the second generating module 34 generates a second header for the set of data. The second header includes a second indicator opposite to the first indicator. The second indicator indicates that the second header includes the compression information field.

The combining module 35 is used for selectively combining the set of data with the first header or the second header to generate a set of combined data. In actual applications, the data processing apparatus 30 can further include a transmitting module for transmitting the set of combined data.

The methods and apparatuses, according to this invention, can be applied in different kinds of communication systems that have similar compression problems. The aforementioned GPRS communication system is an actual example. This invention can generate different SNDCP headers based on compression conditions of data and selectively decrease the data volume occupied by DCOMP fields and PCOMP fields. Thus, transmission speeds in wireless communication systems are improved.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. In a communication system, a method for processing a set of data among N sets of data, N being a natural number, the method comprising:
(a) judging whether the set of data is compressed, and if a first judging result of step (a) is NO, performing step (b); and
(b) generating a first header for the set of data, and the first header comprising a first indicator for indicating that the first header does not comprise a compression information field.

2. The method of claim 1, the method further comprising:
(c) if the first judging result of step (a) is YES, judging whether the set of data is the first set of data among the N sets of data, and if a second judging result of step (c) is NO, performing step (b).

3. The method of claim 2, the method further comprising:
(d) if the second judging result of step (c) is YES, generating a second header for the set of data, the second header comprising a second indicator opposite to the first indicator, and the second indicator indicating that the second header comprises the compression information field.

4. The method of claim 3, the method further comprising:
(e) selectively combining the set of data with the first header or the second header to generate a set of combined data.

5. The method of claim 4, the method further comprising:
(f) transmitting the set of combined data.

6. The method of claim 5, the method further comprising:
(g) receiving the set of combined data.

7. The method of claim 6, the method further comprising:
(h) judging whether the set of combined data comprises the first header or the second header; and
(i) if the set of combined data comprises the second header, decompressing the set of combined data before further processing it.

8. The method of claim 1, wherein the communication system is a mobile station conforming to GPRS specifications.

9. The method of claim 8, wherein the first header and the second header are sub-network dependent convergence protocol (SNDCP) headers.

10. The method of claim 9, wherein the compression information field comprises a data compression coding (DCOMP) field and a protocol control information compression coding (PCOMP) field.

11. In a communication system, an apparatus for processing a set of data among N sets of data, N being a natural number, the apparatus comprising:
a first judging module for judging whether the set of data is compressed;
and
a first generating module operated by a first judging result of the first judging module, if the first judging result of the first judging module is NO, the first generating module generating a first header for the set of data, and the first header comprising a first indicator for indicating that the first header does not comprise a compression information field.

12. The apparatus of claim 11, the apparatus further comprising:
a second judging module operated by the first judging result of the first judging module, if the first judging result of the first judging module is YES, the second judging module judging whether the set of data is the first set of data among the N sets of data, and if a second judging result of the second judging module is NO, the second judging module operating the first generating module to generating the first header for the set of data.

13. The apparatus of claim 12, the apparatus further comprising:
a second generating module operated by the second judging result of the second judging module, if the second judging result of the second judging module is YES, the second generating module generating a second header for the set of data, the second header comprising a second indicator opposite to the first indicator, and the second indicator indicating that the second header comprises the compression information field.

14. The apparatus of claim 13, the apparatus further comprising:
a combining module for selectively combining the set of data with the first header or the second header to generate a set of combined data.

15. The apparatus of claim 14, the apparatus further comprising:
a transmitting module for transmitting the set of combined data.

16. The apparatus of claim 11, wherein the communication system is a mobile station conforming to GPRS specifications.

17. The apparatus of claim 16, wherein the first header and the second header are sub-network dependent convergence protocol layer (SNDCP) headers.

18. The apparatus of claim 17, wherein the compression information field comprises a data compression coding (DCOMP) field and a protocol control information compression coding (PCOMP) field.

19. A method for processing a plurality of data sets in a communication system, the method comprising:
(a) judging whether a data set among the plurality of data sets is compressed;
(b) if the data set is not compressed, combining a first header and the data set to generate a combined data set, the first header comprising a first indicator;
(c) if the data set is compressed, judging whether the data set is the first data set among the plurality of data sets;
(d) if the data set is not the first data set among the plurality of data sets, combining the first header and the data set to generate the combined data set; and
(e) if the data set is the first data set among the plurality of data sets, combining a second header and the data set to generate the combined data set, the second header comprising a second indicator opposite to the first indicator.

20. The method of claim 19, wherein the communication system comprises a first end and a second end, the method further comprising:
receiving the combined data set at the second end from the first end;
at the second end, judging whether the combined data set comprises the first header or the second header; and
if the combined data set comprises the second header, decompressing the combined data set before further processing it.
